(19) United States
(12) Patent Application Publication
(10) Pub. No.: US 2015/0372718 A1
(43) Pub. Date: Dec. 24, 2015

(54) VARIABLE INPUT IMPEDANCE FOR POWERLINE COMMUNICATIONS

(71) Applicant: QUALCOMM Incorporated, San Diego, CA (US)

(72) Inventors: Richard Joseph McConnell, Rancho Cucamonga, CA (US); Faisal Mahmood Shad, Ijamsville, MD (US)

(21) Appl. No.: 14/313,754

(22) Filed: Jun. 24, 2014

(51) Int. Cl. H04B 3/54; H04B 3/46; H04J 3/16

(52) U.S. Cl. CPC H04B 3/544; H04J 3/1694; H04B 3/46

(57) ABSTRACT

A powerline communication (PLC) device can receive a PLC signal transmitted through a powerline medium. The PLC device can compare a destination address of the PLC signal to a device address associated with the PLC device. The input impedance of the PLC device can be configured to an impedance value that is different from an impedance of the powerline medium when the destination address does not match the device address. The input impedance of the PLC device can be returned to an initial value when a PLC message included in the PLC signal is no longer received.

### BACKGROUND

Embodiments described generally relate to the field of communication systems and, more particularly, to powerline communication devices that include a configurable input impedance.

In general, powerline communication (PLC) technology uses an alternating current (AC) powerline as a communication medium to carry high frequency, wideband PLC signals. A PLC device coupled to a powerline medium can send and receive PLC signals with other PLC devices also coupled to the powerline medium. A PLC device sends PLC signals to specific PLC devices through a one-to-one (unicast) or a one-to-many (broadcast/multicast) message.

A transmitting PLC device generates and couples PLC signals that include encoded PLC data onto the powerline medium. If a PLC signal is broadcast or unicast to a receiving PLC device, then the PLC data is decoded from the PLC signal. Some PLC devices coupled to the powerline medium between the transmitting PLC device and the receiving PLC device can adversely affect the PLC signal. For example, a PLC device can reduce the amplitude or distort the PLC signal as the PLC signal propagates past the PLC device on the powerline medium. Thus, the receiving PLC device may not reliably decode the PLC data from the PLC signal.

### SUMMARY

Various embodiments of a PLC device that include a configurable input impedance are disclosed. In one embodiment, a destination address associated with a PLC signal received by the PLC device through a powerline medium is determined. The PLC device determines whether the destination address matches the address of the PLC device. The input impedance of the PLC device is modified based, at least in part, on an estimate of the impedance of the powerline medium and whether the destination address matches the address of the PLC device.

### BRIEF DESCRIPTION OF THE DRAWINGS

The present embodiments may be better understood, and numerous objects, features, and advantages made apparent to those skilled in the art by referencing the accompanying drawings.

FIG. 1 is a block diagram of one embodiment of a PLC network including multiple PLC devices configured to transmit and receive unicast PLC messages.

FIG. 2 is a flow diagram illustrating example operations for receiving unicast PLC messages.

FIG. 3 is a block diagram of one embodiment of a PLC network including multiple PLC devices configured to transmit and receive broadcast or multicast PLC messages.

FIGS. 4A and 4B is a flow diagram illustrating example operations for receiving broadcast or multicast PLC messages.

FIG. 5 is a simplified diagram illustrating one embodiment of a PLC device that includes a variable impedance unit.

FIG. 6 is a block diagram of an exemplary embodiment of an electronic device that includes a variable impedance determination unit.

### DESCRIPTION OF EMBODIMENT(S)

The description that follows includes exemplary systems, methods, instruction sequences, and computer program products that embody the present disclosure. However, it is understood that the described embodiments may be practiced without these specific details. Well-known instruction instances, protocols, structures, and techniques have not been shown in detail in order not to obfuscate the description.

A PLC device can transmit and receive PLC signals within a PLC network. Some instances of the PLC network can include three or more PLC devices coupled to a powerline medium. For example, the PLC network can include a first PLC device configured as a broadband gateway, a second PLC device coupled to a computing device, and a third PLC device coupled to a media device such as a media player. In one embodiment, a transmitting PLC device can send a unicast PLC message to a single receiving PLC device. In another embodiment, the transmitting PLC device can send a broadcast or multicast PLC message to two or more receiving PLC devices.

The transmitting PLC device encodes PLC data using one or more tones in a PLC signal and then couples the PLC signal to the powerline medium. PLC signal characteristics, such as, but not limited to, PLC signal strength and signal-to-noise ratio (SNR) can vary as the PLC signal propagates through the powerline medium. For example, characteristics of the powerline medium, such as impedance, length, and transmission parameters can affect the PLC signal characteristics at different points of the powerline medium. Typically, when an input impedance of the receiving PLC device approximately matches the powerline medium impedance (i.e., the input impedance of the receiving PLC device is similar in value to the powerline medium impedance), the PLC signals are effectively coupled to the receiving PLC device. Impedance matching between the receiving PLC device and the powerline medium can minimize PLC signal loss and PLC signal reflection and reduce other effects on the PLC signal characteristics. As a result, the receiving PLC device can decode the PLC data with little or no errors.

The location (or position) of a PLC device with respect to the powerline medium can negatively affect the PLC signal characteristics of the PLC signal. For example, the powerline medium resistance can cause the PLC signal strength to decrease as the distance between the receiving PLC device and the transmitting PLC device increases. In instances where several intermediate PLC devices are located between the transmitting PLC device and the receiving PLC device, each intermediate PLC device can cause the PLC signal strength to decrease. Accordingly, the PLC signal strength can fall to levels that reduce data transfer rates or cause the PLC signal to be unreliable.

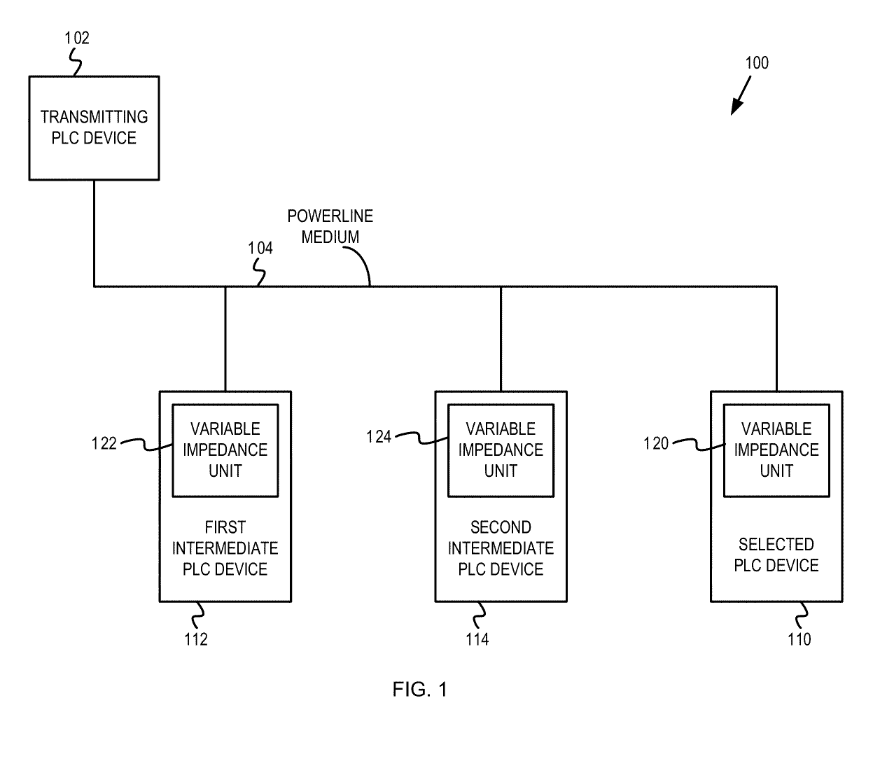

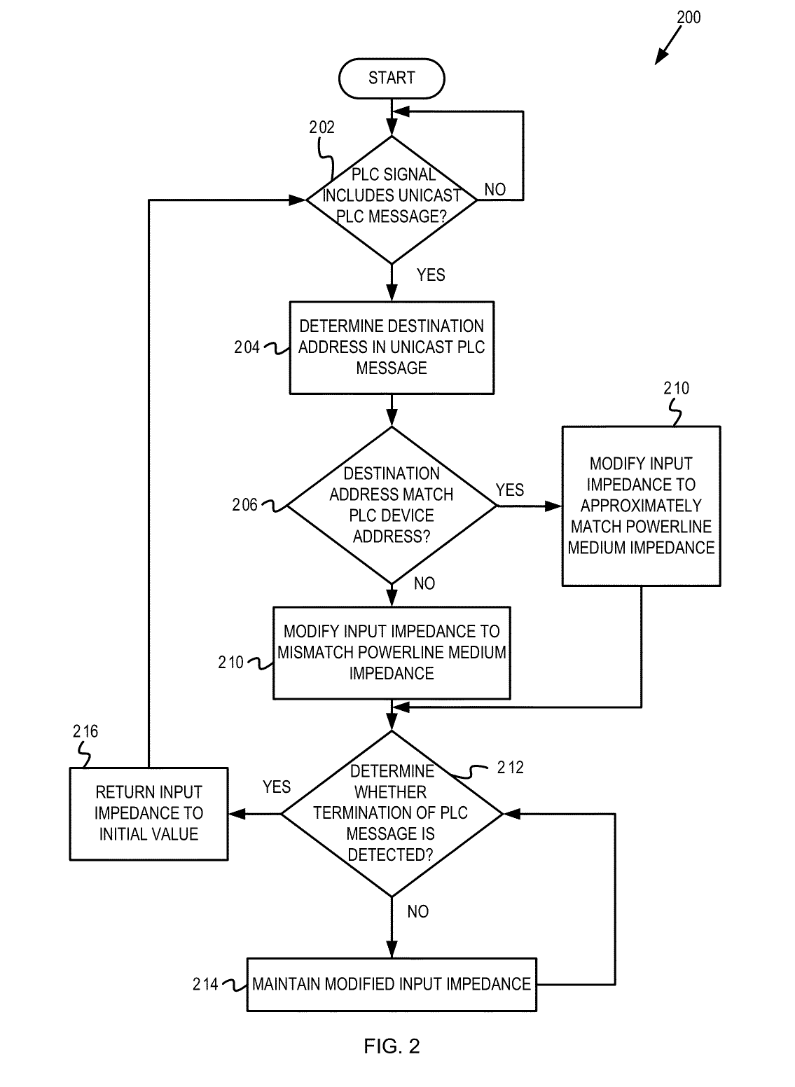

In one embodiment, the transmitting PLC device can select a PLC device (the “selected PLC device”) to receive a unicast PLC message. The input impedance of the selected PLC device can be modified to approximately match the powerline medium impedance to effectively couple the PLC signal to the selected PLC device. The input impedance of an intermediate PLC device can be modified to mismatch the powerline medium impedance which may improve the PLC signal characteristics for the selected PLC device. For example, mismatching the powerline medium impedance at the intermediate PLC device can cause less coupling of the PLC signal to the intermediate PLC device. This can increase the PLC signal strength at the selected PLC device and improve PLC data reliability. Techniques for modifying input impedance of PLC devices for receiving unicast PLC messages will be described in more detail below in conjunction with FIGS. 1 and 2.

In another embodiment, the transmitting PLC device can send a broadcast or multicast PLC message to two or more selected PLC devices. The selected PLC device that is located farthest (i.e., at the longest distance) from the transmitting PLC device as compared to the other selected PLC device(s) can be referred to as a terminal PLC device. The input impedance of the terminal PLC device can be modified so that the input impedance is optimally matched to the powerline medium impedance to effectively couple the PLC signal to the terminal PLC device. The input impedance of the other selected PLC devices can be modified so that there is a non-optimal match (also referred to as a “controlled mismatch”) between the input impedance of the other selected PLC device and the powerline medium impedance.

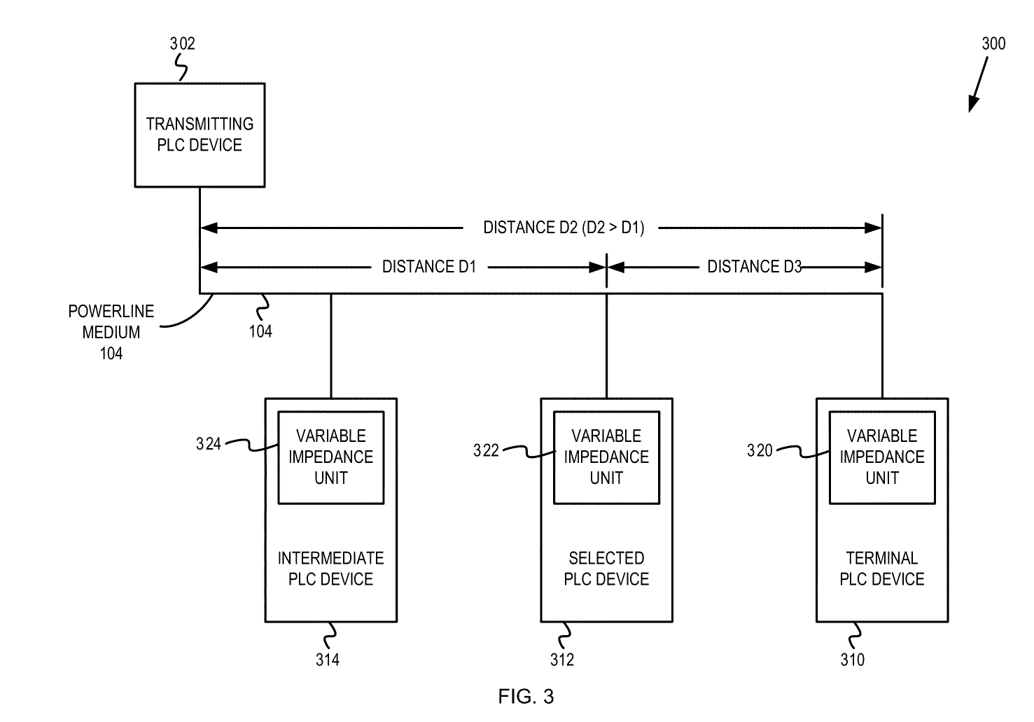

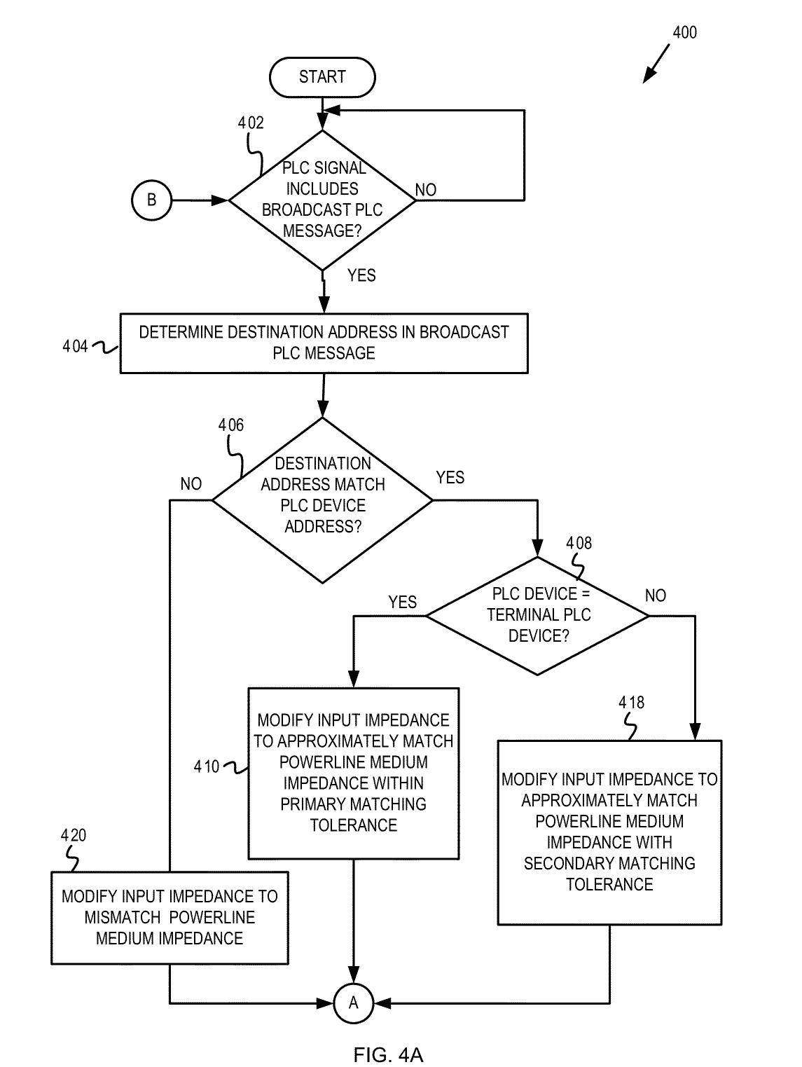

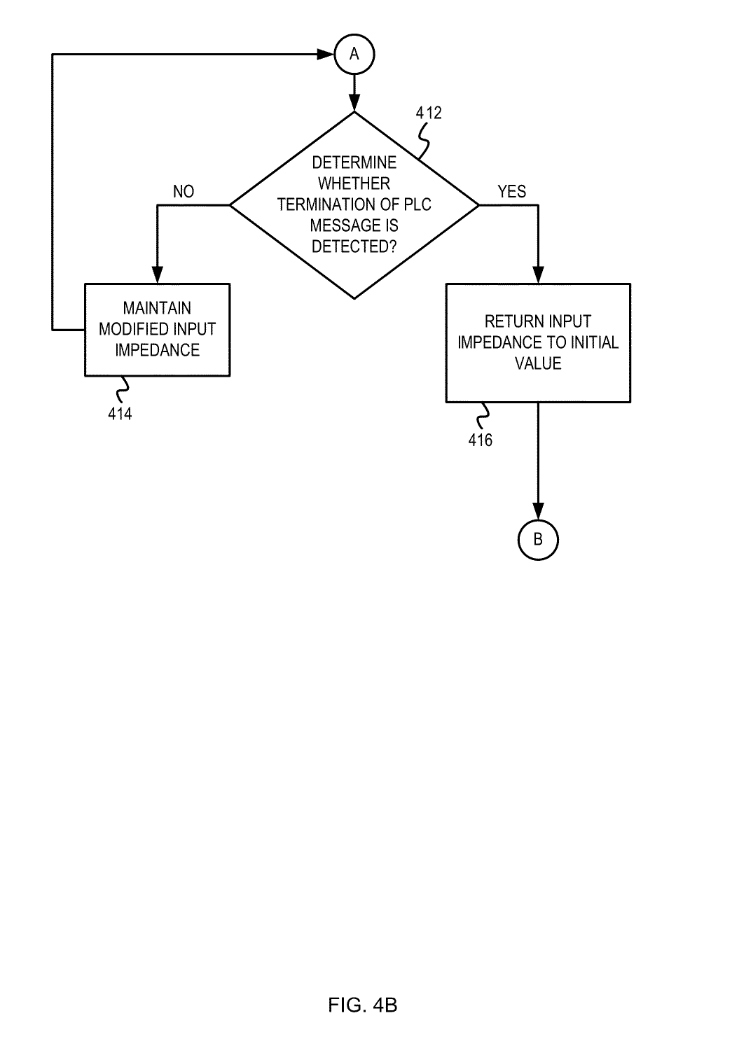

Introducing a controlled mismatch between the input impedance of the other selected PLC device and the powerline medium impedance can reduce the amount of the PLC signal coupled to the other selected PLC device while still allowing reception and decoding of the PLC signal. Since the amount of PLC signal that is coupled to the other selected PLC devices is reduced, a larger portion of the PLC signal can be propagated downstream through the powerline medium such that the terminal PLC device receives the PLC signal with sufficient signal strength to reliably decode the PLC signal. The input impedance of the intermediate PLC devices (i.e., the PLC devices not selected to receive the broadcast or multicast PLC message) can be modified to mismatch the powerline medium impedance such that little or no coupling of the PLC signal occurs at the intermediate PLC devices. Techniques for modifying input impedances of PLC devices for receiving broadcast or multicast PLC messages will be described in more detail below in conjunction with FIGS. 3 and 4. Hereinafter, the terms broadcast and multicast are used interchangeably and refer to sending PLC messages to two or more PLC devices contemporaneously.

FIG. 1 is a block diagram of one embodiment of a PLC network 100 including multiple PLC devices configured to transmit and receive unicast PLC messages. The PLC network 100 can include a transmitting PLC device 102, a first intermediate PLC device 112, a second intermediate PLC device 114, and a selected PLC device 110, all coupled to a powerline medium 104. Typically, a unicast PLC message is a point-to-point message sent from the transmitting PLC device 102 to a specific PLC device, such as the selected PLC device 110. An address can be assigned to each of the first intermediate PLC device 112, the second intermediate PLC device 114 and the selected PLC device 110 to identify the respective PLC devices. The transmitting PLC device 102 can include a destination address within the unicast PLC message to identify the selected PLC device 110. The unicast message may include a preamble, a frame control or header, and a message body. The first intermediate PLC device 112, the second intermediate PLC device 114 and the selected PLC device 110 can receive the PLC signals including the unicast PLC message from the transmitting PLC device 102, and determine whether or not to process the unicast PLC message based, at least in part, on the destination address.

The first intermediate PLC device 112 includes a variable impedance unit 122 configured to modify the input impedance of the first intermediate PLC device 112 to match or mismatch the powerline medium impedance. Similarly, the second intermediate PLC device 114 and the selected PLC device 110 can each include a variable impedance unit 124 and 120, respectively, configured to modify the input impedance of its respective PLC device. In one embodiment, the variable impedance units 120-124 can be configured to support a specific PLC signal bandwidth, for example, between 2 MHz and 68 MHz. The operation and configuration of the variable impedance units 120-124 will be described in more detail below in conjunction with FIGS. 2-5.

Typically, when the input impedance of a PLC device approximately matches the powerline medium impedance, more of the PLC signal can be coupled to the PLC device, which can improve PLC signal characteristics by, for example, increasing the PLC signal strength and/or SNR at the PLC device. Improved impedance matching can also help mitigate neighbor network interference with PLC devices which implement transmit power control. Impedance matching may also facilitate compliance with regulatory limits on the radiated and conducted emissions from the PLC device. The variable impedance unit 120 can modify the input impedance of the selected PLC device 110 to approximately match the powerline medium impedance in order to couple a larger portion of the PLC signal and improve the PLC signal characteristics at the selected PLC device 110. On the other hand, when the input impedance of the PLC device does not match (i.e., mismatches) the powerline medium impedance, a smaller portion of the PLC signal can be coupled to the PLC device. This diminishes the PLC signal characteristics at the PLC device while allowing a larger portion of the PLC signal to propagate in the powerline medium. Therefore, the variable impedance units 122-124 can modify the input impedance of the first intermediate PLC device 112 and the second intermediate PLC device 114 to mismatch the powerline medium impedance in order to couple a smaller portion of the PLC signal at their respective PLC devices to reduce the effect on propagating PLC signals in the powerline medium.

The transmitting PLC device 102 can transmit the unicast PLC message by coupling the PLC signals to the powerline medium 104. The unicast PLC message can include the destination address of the selected PLC device 110 with the PLC data. The first intermediate PLC device 112, the second intermediate PLC device 114 and the selected PLC device 110 can each determine if the destination address matches its corresponding address. If the destination address matches one of the addresses, then the variable impedance unit of the corresponding PLC device can be configured to approximately match the input impedance to the powerline medium impedance. If the destination address does not match the address of the receiving PLC device, then the variable impedance unit of the corresponding PLC device can be configured to mismatch the input impedance with reference to the powerline medium impedance.

In some embodiments, the input impedance associated with the selected PLC device 110 may be optimally matched to the powerline medium impedance. In some embodiments, the input impedance of the selected PLC device 110 can approximately match the powerline medium impedance when the input impedance is within a primary matching tolerance of the powerline medium impedance. In one embodiment, the primary matching tolerance can be specified as a percentage. For example, if the powerline medium impedance is 200 ohms and the primary matching tolerance is ±10%, then an input impedance that matches the powerline medium impedance can be between 180 and 220 ohms. In some embodiments, the powerline medium impedance and/or the primary matching tolerance can be different in different networks. For example, the powerline medium impedance can be between 175 to 250 ohms and the primary matching tolerance can be between ±10% and ±15%. In some embodiments, the powerline medium impedance and the primary matching tolerance can be predefined, configurable by a user or determined by a central coordinator (not shown). In some embodiments, the powerline medium impedance and the primary matching tolerance can be determined by the variable impedance unit 120 of the selected PLC device 110, the variable impedance unit 122 of the first intermediate PLC device 112, or the variable impedance unit 124 of the second intermediate PLC device 114.

A PLC device may implement various techniques to determine the powerline medium impedance. In some embodiments, the PLC device may sequentially vary its input impedance and determine received signal characteristics that correspond to each value of the input impedance. The received signal characteristics may include received signal strength indication (RSSI), signal-to-noise ratio (SNR), bit error rate (PER), packet error rate (PER), attenuation level, and/or other suitable signal characteristics. The received signal characteristics may be determined based, at least in part, on PLC signals that were received by the PLC device at each value of the input impedance. The PLC device may determine an appropriate value of the input impedance based, at least in part, on the received signal characteristics associated with each value of the input impedance. For example, the variable impedance unit 120 may configure the PLC device 110 to a first input impedance. A first set of received signal characteristics may be determined based, at least in part, on PLC signals that were received at the PLC device 110 when the PLC device 110 was configured with the first input impedance. The variable impedance unit 120 may then configure the PLC device 110 to a second input impedance. A second set of received signal characteristics may be determined based, at least in part, on PLC signals that were received at the PLC device 110 when the PLC device 110 was configured with the second input impedance. In this embodiment, the PLC device 110 may not determine an actual value of the powerline medium impedance. Instead, the PLC device 110 may select the input impedance that is associated with the best performance. For example, the PLC device 110 may select the first input impedance if the SNR associated with the first input impedance exceeds the SNR associated with the second input impedance.

In another embodiment, a powerline medium impedance that is frequency dependent (“frequency dependent powerline medium impedance”) may be determined. A PLC device may inject a known voltage or current into the powerline medium. The PLC device may subsequently measure the current or voltage and may determine the powerline impedance based on knowledge of known electrical network components (e.g., powerline medium transformer) and impact of receive coupling. The PLC device may implement a suitable digital signal processing (DSP) algorithm to estimate the frequency dependent powerline medium impedance. In this embodiment, the PLC device may configure its input impedance to match or mismatch the frequency dependent powerline medium impedance depending on whether the PLC device is a terminal PLC device, another selected PLC device, or an intermediate PLC device.

In a similar manner, the input impedance of the intermediate PLC devices 112-114 can mismatch the powerline medium impedance when the input impedance is greater than or equal to an impedance mismatch tolerance of the powerline medium impedance. The impedance mismatch tolerance can be specified as a percentage. For example, if the powerline medium impedance is 200 ohms and the impedance mismatch tolerance is ±20%, then a mismatched input impedance can be less than or equal to 160 ohms and greater than or equal to 240 ohms. As described above, mismatching the input impedance of the intermediate PLC device can reduce the coupling of the PLC signal to the intermediate PLC device. In general, as the input impedance of the intermediate PLC device further mismatches the powerline medium impedance, the coupling effectiveness decreases between the PLC signal and the intermediate PLC device. In some embodiments, if the input impedance of the other selected PLC devices is adjusted to be lower than the powerline medium impedance, the PLC signal received at the other selected PLC device may be attenuated. This can impair the quality of the PLC signal received at the other selected PLC device. Therefore, in some embodiments, the input impedance of the other selected PLC devices is adjusted to be higher than the powerline medium impedance. In some embodiments, the input impedance mismatch can be large. For example, the input impedance of the intermediate PLC device can be modified to be twice the powerline medium impedance. The large impedance mismatch may corrupt a portion of the unicast PLC message at the intermediate PLC device. However, since the intermediate PLC device with the large impedance mismatch is not the selected PLC device 110, the intermediate PLC device can ignore the corrupt unicast PLC message. The greater the mismatch between the input impedance and the powerline medium impedance, the less PLC signal is coupled to the intermediate PLC device leaving more PLC signal (e.g., greater PLC signal strength) to propagate downstream through the powerline medium 104. Thus, increasing the amount of mismatch between the PLC medium impedance and the input impedance of the intermediate PLC devices (e.g., the first intermediate PLC device 112 and the second intermediate PLC device 114) can increase the PLC signal available for other PLC devices coupled to the powerline medium 104 (e.g., the selected PLC device 110). Techniques for receiving the unicast PLC message will be described in more detail below in conjunction with FIG. 2.

FIG. 2 is a flow diagram 200 illustrating example operations for receiving unicast PLC messages. The operations of flow diagram 200 are described with reference to the PLC network 100 for illustration purposes and not as a limitation. The example operations can be performed by one or more components of a PLC device in the PLC network 100; for example, the operations can be performed by one or more of a network interface, a processor, and a memory of the PLC device.

The flow begins at block 202, where the PLC device determines if the PLC signal includes a unicast PLC message. For example, the PLC device can receive the PLC signal and decode at least a portion of the PLC data included in the PLC signal (e.g., the Frame Control field in HomePlug standard compatible implementations). The PLC device may determine if the PLC signal includes a unicast PLC message. In one embodiment, the unicast PLC message can be a point-to-point message sent from the transmitting PLC device 102 to the selected PLC device 110. If the PLC signal does not include a unicast PLC message, then the flow returns to block 202. If the PLC signal includes a unicast PLC message, then the flow continues to block 204.

At block 204, the destination address included in the unicast PLC message is determined. Generally, the transmitting PLC device 102 sends the unicast PLC message to a particular (selected) PLC device. For example, the unicast PLC message can identify the selected PLC device 110 by including the address of the selected PLC device 110 as the destination address. The flow continues to block 206.

At block 206, the destination address included in the unicast PLC message is compared to the address of the PLC device. If the destination address matches the address of the PLC device, then the PLC device can determine it is the selected PLC device 110 and the flow continues to block 208.

At block 208, the input impedance of the selected PLC device 110 can be modified to approximately match the powerline medium impedance. In one embodiment, the variable impedance unit 120 can be configured to modify the input impedance of the selected PLC device 110 to approximately match the powerline medium impedance. For example, the input impedance of the selected PLC device 110 can be modified to be within a matching tolerance of the powerline medium impedance. The flow continues to block 212.

Returning to block 206, if the destination address included the unicast PLC message does not match the address of the PLC device, then the PLC device can determine it is an intermediate PLC device (e.g., the first intermediate PLC device 112 or the second intermediate PLC device 114) and the flow continues to block 210. At block 210, the input impedance of the intermediate PLC device can be modified to mismatch the powerline medium impedance. In one embodiment, the input impedance of the intermediate PLC device can be modified to mismatch the powerline medium impedance by modifying the input impedance to an amount greater than or equal to the impedance mismatch tolerance of the powerline medium impedance. The flow continues to block 212.

At block 212, the PLC device can determine whether a termination of the unicast PLC message is detected. For example, the unicast PLC message can terminate when the transmitting PLC device 102 has completed sending the PLC data associated with the unicast PLC message. In some embodiments, the termination of the unicast PLC message can be inferred from signaling protocol information that is provided at the start of the message. In other embodiments, the termination of the unicast PLC message can be determined through an ongoing physical layer carrier sensing mechanism. If the PLC device determines that the termination of the unicast PLC message is not detected (i.e., the unicast PLC message is still being received), then the flow continues to block 214. At block 214, the modified input impedance of the PLC device is maintained. Thus, if the input impedance of the PLC device was modified to approximately match the powerline medium impedance at block 208, then the approximately matching input impedance of the PLC device is maintained at block 214. Conversely, if the input impedance of the PLC device was modified to mismatch the powerline medium impedance at block 210, then the mismatched input impedance of the PLC device is maintained at block 214. The flow returns to block 212.

Returning to block 212, if the PLC device determines that the termination of the unicast PLC message is detected (i.e., the unicast PLC message is no longer being received), then the flow continues to block 216. At block 216, the input impedance of the PLC device can be returned to an initial value. Returning the input impedance of the PLC device to the initial value can prepare the PLC device to receive another PLC message by setting the input impedance to a predetermined value. In some embodiments, the initial value of the input impedance of the receiving PLC device can be determined in accordance with a HomePlug or an IEEE 1901 specification. In some embodiments, the initial value of the input impedance may be a value at which the PLC device can receive at least a portion of the PLC message to determine the destination address. The flow returns to block 202.

In one embodiment, the PLC network 100 can include a high-traffic pathway for unicast PLC messages. The input impedance of the PLC devices participating in the high-traffic pathway can be configured to support the unicast PLC messages. In some embodiments, the PLC devices associated with the high-traffic pathway can be configured in anticipation of receiving the unicast PLC messages. For example, if data is frequently streamed from a broadband source to a computer coupled to the powerline medium 104, then a high-traffic pathway may exist between the transmitting PLC device 102 (operating as the broadband gateway to a network) and the selected PLC device 110 that may be coupled to the computer. The input impedance of the PLC devices associated with the high-traffic pathway can be persistently modified. For example, the modified input impedances of the PLC devices can persist for several seconds or minutes to anticipate the frequently streamed data. In one implementation, a central coordinator of the PLC network 100 (not shown) can analyze traffic patterns and determine which PLC devices participate in the high-traffic pathway. In another implementation, the central coordinator can collect traffic data and determine which PLC devices participate in the high-traffic pathway based on historical traffic data. The central coordinator can configure the PLC devices associated with the high-traffic pathways to approximately match or mismatch their respective input impedances based, at least in part, on the analyzed traffic patterns or the historical traffic data.

In another embodiment, time-division multiple access (TDMA) techniques may be used in the PLC network 100 to control network access. TDMA techniques can include scheduling information regarding transmissions from the transmitting PLC device 102 to the selected PLC device 110. Thus, the input impedances of the PLC devices can be modified, as described above, and in accordance with the TDMA schedule. For example, the central coordinator can modify the input impedance of the selected PLC device 110 to approximately match the powerline medium impedance based, at least in part, on the TDMA schedule. Similarly, the central coordinator can also modify the input impedance of the intermediate PLC devices to mismatch the powerline medium impedance. In still another embodiment, network access can be controlled with carrier sense, multiple access (CSMA) techniques. For example, the PLC devices in the PLC network 100 can detect request-to-send (RTS) and clear-to-send (CTS) messages that precede some PLC messages. The RTS/CTS messages are typically broadcast to all PLC devices associated with the PLC network 100. In response to detecting the broadcast RTS/CTS messages, the input impedances of the PLC devices can be modified, as described above. Thus, techniques to control network access can be used to predict when a PLC message will be transmitted and determine how to modify the input impedance of the PLC devices.

FIGS. 1 and 2 describe techniques for transmitting a unicast PLC message to a single destination PLC device. In other embodiments, the transmitting PLC device can send a broadcast or multicast PLC message to two or more selected PLC devices. When the input impedance of a PLC device is matched to the powerline medium impedance, the maximum amount of the PLC signal is transferred from the powerline medium to the PLC device. However, when the PLC signal is intended for multiple selected PLC devices, the input impedance of some of the selected PLC devices may not match the powerline medium impedance. In other words, the input impedance of some of the selected PLC devices may have a mismatch relative to the powerline medium impedance. Operations for varying the input impedance so that multiple PLC devices can receive a broadcast or multicast PLC message are described below.

FIG. 3 is a block diagram of one embodiment of a PLC network 300 including multiple PLC devices configured to transmit and receive broadcast or multicast PLC messages. In contrast to the unicast PLC messages described in FIGS. 1 and 2, a broadcast PLC message is typically a one-to-many message sent from a transmitting PLC device to two or more PLC devices. Similarly, a multicast PLC message can be sent to two or more PLC devices. The broadcast PLC message can be sent to substantially all the PLC devices in the PLC network 300, while the multicast PLC message can be sent to a subset of the PLC devices in the PLC network 300. The PLC network 300 can include a transmitting PLC device 302, a terminal PLC device 310, a selected PLC device 312, and an intermediate PLC device 314, all coupled to the powerline medium 104. The terminal PLC device 310 and the selected PLC device 312 can be included in a broadcast group selected to receive the broadcast PLC message. In other embodiments, the broadcast group can include more than two PLC devices. Similar to the intermediate PLC devices described above, the intermediate PLC device 314 is not included in the broadcast group. Therefore, the intermediate PLC device 314 can receive the broadcast PLC message, but may not decode the PLC data. The intermediate PLC device 314 may, however, receive and decode an initial portion of the broadcast PLC message to determine the destination address. The transmitting PLC device 302 may transmit a message for reception by multiple destination PLC devices. Typically, for broadcast/multicast messages, the transmitting PLC device may select a modulation and encoding scheme to enable successful decoding at the selected (and terminal) PLC devices. As will be further described below, the selected (and terminal) PLC devices may optimize their respective input impedance to receive the PLC signal with just enough SNR to decode the PLC signal. In some embodiments, the transmitting PLC device 302 can identify the broadcast group selected to receive the broadcast PLC message through a destination address. The destination address can be included in the broadcast PLC message. The destination address can include substantially all the PLC devices (for a broadcast message) or a subset of the PLC devices (for a multicast message). For example, the destination address can include the addresses of the terminal PLC device 310 and the selected PLC device 312. The address of the intermediate PLC device 314 is not included in the destination address. Thus, the PLC devices can determine whether or not to process the broadcast PLC message based, at least in part, on the destination address.

The terminal PLC device 310, the selected PLC device 312, and the intermediate PLC device 314 can include a variable impedance unit to modify the input impedance of the respective PLC devices. The terminal PLC device 310 can include a variable impedance unit 320, the selected PLC device 312 can include a variable impedance unit 322, and the intermediate PLC device 314 can include a variable impedance unit 324. The operation of the variable impedance units 320-324 will be described in more detail below.

The input impedance of the PLC devices selected to receive the broadcast PLC message (i.e., the terminal PLC device 310 and the selected PLC device 312) can be modified based, at least in part, on the distance between the transmitting PLC device 302 and the respective PLC devices. Here, the distance refers to the electrical distance between the PLC devices. The electrical distance may be characterized, at least in part, by the average signal attenuation in the passband of the communicating PLC devices. As depicted in FIG. 3, the selected PLC device 312 is a distance D1 from the transmitting PLC device 302, while the terminal PLC device 310 is a distance D2 from the transmitting PLC device 302. The distance D1 is less than the distance D2. As described above, the PLC signal strength can decrease as the PLC signal propagates through the powerline medium 104. Thus, the farther a PLC device is from the transmitting PLC device 302, the weaker the PLC signal strength may be. The PLC device included in the broadcast group that is farthest from the transmitting PLC device 302 can be identified as the terminal PLC device 310. Since the terminal PLC device 310 is the farthest from the transmitting PLC device 302, the PLC signal at the terminal PLC device 310 may have the weakest PLC signal strength with respect to the other PLC devices in the broadcast group.

In one embodiment, the input impedance of the terminal PLC device 310 can be modified to approximately match the powerline medium impedance. In some embodiments, the input impedance associated with the terminal PLC device 310 may be optimally matched to the powerline medium impedance. As described above, approximately matching the input impedance of a PLC device to the powerline medium impedance can effectively couple the PLC signal to the PLC device. In some embodiments, the input impedance associated with the terminal PLC device 310 may be matched to the powerline medium impedance to within a primary matching tolerance. For example, the variable impedance unit 320 can modify the input impedance of the terminal PLC device 310 to approximately match the powerline medium impedance within a primary matching tolerance of the powerline medium impedance to effectively couple the PLC signal to the terminal PLC device 310. In some embodiments, the primary matching tolerance may specify a range for approximately matching the input impedance of the terminal PLC device 310 to the powerline medium impedance. The primary matching tolerance may be selected so that the input impedance of the terminal PLC device 310 is optimally matched to the powerline medium impedance.

The broadcast group can include other PLC devices aside from the terminal PLC device 310, yet also selected to receive the broadcast PLC message. The other PLC devices included in the broadcast group may be referred to as selected PLC devices. Although FIG. 3 shows one selected PLC device 312, other embodiments can include more selected PLC devices.

The input impedance of the selected PLC device 312 can be modified to approximately match the powerline medium impedance within a secondary matching tolerance. In some embodiments, the input impedance associated with the selected PLC device 312 may be varied so that there is a non-optimal match (e.g., a controlled mismatch) between the input impedance of the selected PLC device 312 and the powerline medium impedance. If there are multiple selected PLC devices, the input impedance associated with each selected PLC device may be varied so that there is the same amount of controlled mismatch between the powerline medium impedance and the input impedance of each selected PLC device. Alternatively, there may be a different amount of controlled mismatch between the powerline medium impedance and the input impedance associated with some or all of the selected PLC devices.

In some embodiments, the input impedance associated with the selected PLC device 312 may be matched to the powerline medium impedance to within a secondary matching tolerance. The secondary matching tolerance may be selected so that there is a controlled mismatch or a non-optimal match between the input impedance the selected PLC device 312 and the powerline medium impedance. The secondary matching tolerance can be determined such that the broadcast PLC message can be successfully decoded at the selected PLC device 312, without attenuating the PLC signal so much that it adversely affects successful decoding at the terminal PLC device 310. In some embodiments, the secondary matching tolerance can specify an upper limit and a lower limit for approximately matching the input impedance of the selected PLC device 312 to the powerline medium impedance. For example, the powerline medium impedance can be 200 ohms and the secondary matching tolerance can have a lower limit of ±10% and an upper limit of ±15%. In this example, the variable impedance unit 322 can modify the input impedance of the selected PLC device 312 to values between 170 and 180 ohms or between 220 and 230 ohms. In one embodiment, the lower limit of the secondary matching tolerance can be greater than or equal to the primary matching tolerance. For example, if the primary matching tolerance is ±10%, then the lower limit of the secondary matching tolerance can be greater than or equal to ±10%. When the lower limit of the secondary matching tolerance is greater than or equal to the primary matching tolerance, the input impedance of the terminal PLC device 310 does not overlap the input impedance of the selected PLC device 312. Furthermore, the input impedance of the terminal PLC device 310 can be closer to the powerline medium impedance (e.g., between 180 and 220 ohms in this example) compared to the input impedance of the selected PLC device 312 (e.g., either 170 and 180 or 220 and 230).

Approximately matching the input impedance to the powerline medium impedance to within the secondary matching tolerance can couple the PLC signal to the selected PLC device 312. However, the secondary matching tolerance can enable a smaller portion of the PLC signal to couple to the selected PLC device 312 as compared to the terminal PLC device 310. The reduced coupling is due, at least in part, to the input impedance of the selected PLC device 312 not being as closely matched to the powerline medium impedance as compared to the input impedance of the terminal PLC device 310. Although the selected PLC device 312 may receive less PLC signal, the selected PLC device 312 may still decode the PLC data with little or no errors. The reduced coupling of the PLC signal at the selected PLC device 312 can cause a portion of the PLC signal to be reflected back to the powerline medium 104. This, in turn, can increase the amount of PLC signal available to propagate through the powerline medium 104. Thus, the approximately matched input impedance of the selected PLC device 312 can couple a portion of the PLC signal to the selected PLC device 312 and allow a larger portion of the PLC signal to propagate through the powerline medium 104 (e.g., to the terminal PLC device 310).

For example, in the PLC network 300 the powerline medium impedance can be 200 ohms. The transmitting PLC device 302 can transmit a broadcast PLC message by coupling the PLC signals to the powerline medium 104. The broadcast PLC message can include a destination address to identify the broadcast group. The PLC devices coupled to the powerline medium 104 can receive the PLC signals and decode at least a portion of the PLC data. If the PLC device has an address that is included in the destination address, then the PLC device can determine whether the PLC device is a terminal PLC device 310 or a selected PLC device 312. For example, the terminal PLC device 310 and/or the selected PLC device 312 can determine distances between PLC devices based, at least in part, on PLC signal strength measurements. In some embodiments, a central coordinator can determine the terminal PLC device 310 and the selected PLC device 312 in the PLC network 300. Techniques for determining distances and operations of the central coordinator will be described in more detail below.

If the PLC device is the terminal PLC device 310, then the input impedance of the terminal PLC device 310 can be modified by the variable impedance unit 320 to approximately match the powerline medium impedance within the primary matching tolerance of the powerline medium impedance. For example, the primary matching tolerance can be ±10%. Thus, the input impedance of the terminal PLC device 310 can be between 180 and 220 ohms.

If the PLC device is the selected PLC device 312, then the input impedance of the selected PLC device 312 can be modified by the variable impedance unit 322 to approximately match the powerline medium impedance within the secondary matching tolerance of the powerline medium impedance. For example, the secondary matching tolerance can be between ±20% and ±25%. Thus, the input impedance of the selected PLC device 312 can be between 240 and 250 ohms or between 150 and 160 ohms. In this example, the primary matching tolerance does not overlap the secondary matching tolerance. Thus, the input impedance of the terminal PLC device 310 is distinct from the input impedance of the selected PLC device 312. Furthermore, the relationship of the primary matching tolerance to the secondary matching tolerance can modify the input impedance of the terminal PLC device 310 to be closer to the powerline medium impedance than the input impedance of the selected PLC device 312. Accordingly, more PLC signal may be coupled to the terminal PLC device 310 compared to the selected PLC device 312. In other words, the primary matching tolerance may be selected so that the input impedance of the PLC device closely matches (e.g., is equal to or approximately equal to) the powerline medium impedance. The secondary matching tolerance may be selected so that the input impedance of the PLC device does not closely match from the powerline medium impedance. For example, for a 200 ohm powerline medium impedance, the primary matching tolerance may be selected so that the input impedance of the PLC device is approximately equal to 200 ohms. In this example, the secondary matching tolerance may be selected so that the input impedance of the PLC device is 150 ohms.

In one embodiment, a central coordinator (not shown) of the PLC network 300 can determine distance information associated with the PLC devices coupled to the powerline medium 104. A PLC signal can be transmitted through the powerline medium 104 with a known PLC signal strength. The central coordinator can monitor the PLC signal strength associated with the PLC devices. For this, the central coordinator may receive notifications of estimated signal strengths that are measured and reported by the PLC devices using appropriate higher layer signal mechanisms. Since the PLC signal strength decreases as the PLC signal propagates through the powerline medium 104, the central coordinator can determine distances to the PLC devices based, at least in part, on the PLC signal strength. Thus, the central coordinator can provide distance information to the PLC devices in the PLC network 300. In another embodiment, since the central coordinator can determine distance information associated with the PLC devices, the central coordinator can also determine whether a PLC device is the terminal PLC device 310 or the selected PLC device 312.

In one embodiment, the central coordinator can be a PLC device coupled to the powerline medium 104. For example, the intermediate PLC device 314 can be the central coordinator in PLC network 300. In another embodiment, the central coordinator can be distributed between two or more PLC devices in the PLC network 300.

In one embodiment, if the selected PLC device 312 receives a PLC signal and decodes the PLC data with little or no errors, then the input impedance of variable impedance unit 322 can be maintained. The input impedance of the selected PLC device 312, although mismatching the powerline medium impedance, is close enough to permit decoding of the PLC data. On the other hand, if the selected PLC device 312 receives the PLC signal and decodes the PLC data with errors, or an amount of errors is greater than a threshold, then the input impedance of the selected PLC device 312 can be returned to an initial value. In this case, the modified input impedance can reduce performance of the PLC device by, for example, increasing the number of PLC data errors. The initial value can be a default impedance value that can typically allow the PLC signals to be received and the PLC data to be decoded. If setting the input impedance to the initial value is still insufficient to decode the PLC data at the selected PLC device 312, then additional input impedance values may be evaluated.

Since the intermediate PLC device 314 is not included in the broadcast group, the intermediate PLC device 314 does not fully decode the PLC data associated with the broadcast message. For example, the intermediate PLC device 314 can receive the PLC signal from the transmitting PLC device 302 and determine that its address is not included in the destination address of the PLC signal. The input impedance of the intermediate PLC device 314 can be modified to mismatch the powerline medium impedance when the input impedance is greater than or equal to the impedance mismatch tolerance. In some embodiments, the input impedance mismatch between the intermediate PLC device 314 and the powerline medium impedance can be large. For example, the input impedance of the intermediate PLC device 314 can be modified to be twice the powerline medium impedance. The impedance mismatch can corrupt a portion of the broadcast message at the intermediate PLC device 314. However, since the intermediate PLC device 314 is not selected to receive the broadcast PLC message, the intermediate PLC device 314 can ignore the corrupt broadcast message PLC signals. In one embodiment, the impedance mismatch tolerance described with respect to receiving broadcast PLC messages can be similar to the impedance mismatch tolerance described with respect to receiving unicast PLC messages above.

If there are multiple intermediate PLC devices, in some embodiments, the intermediate PLC devices may configure their respective input impedance to a predetermined input impedance value that is mismatched relative to the powerline medium impedance. In other embodiments, some or all of the intermediate PLC devices may independently select their respective input impedance using a centralized or distributed algorithm. As discussed above, the intermediate PLC device may select its input impedance such that little or no coupling of the PLC signal occurs at the intermediate PLC device.

When the PLC signals including the broadcast PLC message are transmitted through the powerline medium 104, the input impedance of the terminal PLC device 310 and the selected PLC device 312 can allow the respective PLC devices to receive the broadcast PLC message with little or no errors. In one embodiment, after configuring the input impedance of the terminal PLC device 310 or the selected PLC device 312, a noise floor measurement of the PLC network 300 can be compared to the measured signal strength of the PLC signal. If modifying the input impedance of the respective PLC devices increases the noise floor measurement and does not increase the PLC signal strength, then the input impedance can be returned to an initial value. If modifying the input impedance does not increase the PLC signal strength by at least a threshold amount, then the input impedance can be returned to an initial value. In another embodiment, the noise floor and/or SNR can be measured before and after modifying the input impedance of the PLC device. For example, if the noise floor measurement increases or SNR measurement decreases after configuring the input impedance, then the input impedance can be returned to an initial value. Thus, optimizing the input impedance can help improve the decoding performance of a PLC message when the primary sources of noise and interference are internal to (i.e., within) the PLC device.

FIGS. 4A and 4B is a flow diagram 400 illustrating example operations for receiving broadcast PLC messages. The operations of flow diagram 400 are described with reference to the PLC network 300 for illustration purposes and not as a limitation. The flow begins at block 402, where the PLC device determines if the PLC signal includes a broadcast PLC message. For example, the PLC device can receive the PLC signal, decode at least a portion of the PLC data included in the PLC signal, and determine if the PLC signal includes a broadcast PLC message. In one embodiment, the broadcast PLC message can be a one-to-many message sent from the transmitting PLC device 302 to a broadcast group in the PLC network 300. If the PLC signal does not include a broadcast PLC message, then the flow returns to block 402. If the PLC signal includes a broadcast PLC message, the flow continues to block 404.

At block 404, the destination address included in the broadcast PLC message is determined. The transmitting PLC device 302 can send the broadcast PLC message to a broadcast group. The broadcast PLC message can identify the PLC devices included in the broadcast group by including a destination address corresponding to the PLC devices in the broadcast group. For example, broadcast PLC message can identify the terminal PLC device 310 and the selected PLC device 312 by including the address corresponding to the PLC devices (i.e., the address for the broadcast group) in the broadcast PLC message. In one embodiment, the destination address can include bit fields that may be configured to specify multiple PLC devices. For example, a subset of the bit fields of the destination address may be set to a predetermined pattern to match the addresses of multiple PLC devices. In another embodiment, multiple PLC device addresses can be included in the destination address. The flow continues to block 406.

At block 406, the destination address included in the broadcast PLC message is compared to the address of the PLC device. If the destination address matches the address of the PLC device, then the flow continues to block 408. The transmitting PLC device 302 can select PLC devices in a broadcast group to receive the broadcast PLC message. For example, since the broadcast group includes the terminal PLC device 310 and the selected PLC device 312, the destination address can match the address of the terminal PLC device 310 and the selected PLC device 312 simultaneously.

At block 408, if the PLC device is the terminal PLC device 310, then the flow continues to block 410. In one embodiment, the central coordinator can determine whether the PLC device is the terminal PLC device 310. In another embodiment, the PLC device can determine relative distances between the PLC devices in the PLC network 300 and determine if the PLC device is the terminal PLC device 310. For example, the terminal PLC device 310 can determine the distance D2 between the terminal PLC device 310 and the transmitting PLC device 302 based, at least in part, on the received PLC signal strength of the PLC signal transmitted by the PLC device 302. The terminal PLC device 310 can determine a distance D3 between the selected PLC device 312 and the terminal PLC device 310 based, at least in part, on the received PLC signal strength of the PLC signal transmitted by the selected PLC device 312. The terminal PLC device 310 can determine relative positions of the selected PLC device 312 and the terminal PLC device 310 based on the distance D2 and the distance D3. In some embodiments, the terminal PLC device 310 may estimate the distance D1 based, at least in part, on the distance D2 and the distance D3.

At block 410, the input impedance of the PLC device can be modified to approximately match the powerline medium impedance within the primary matching tolerance. Since the PLC device is the terminal PLC device 310, the PLC device is located the farthest from the transmitting PLC device 302. Therefore, the input impedance of the terminal PLC device 310 can be modified to approximately match the powerline medium impedance within the primary matching tolerance to provide an effective coupling for the PLC signal. In one embodiment, the variable impedance unit 320 of the terminal PLC device 310 can modify the input impedance to be less than or equal to the primary matching tolerance of the powerline medium impedance. The flow continues to block 412 in FIG. 4B.

Returning to block 408, if the PLC device is not the terminal broadcast PLC device 310, then flow continues to block 418. At block 418, the input impedance of the PLC device can be modified to approximately match the powerline medium impedance within a secondary matching tolerance. In one embodiment, since the PLC device is determined not to be the terminal PLC device 310 at block 408, at block 418, the PLC device can be the selected PLC device 312. Therefore, the variable impedance unit 322 of the selected PLC device can modify the input impedance to be within the secondary matching tolerance of the powerline medium impedance. The flow continues to block 412 in FIG. 4B.

Returning to block 406, if destination address does not match the address of the PLC device, then the flow continues to block 420. Since the address did not match the destination address, the PLC device can be the intermediate PLC device 314. At block 420, the input impedance of the intermediate PLC device 314 can be modified to be greater than or equal to the impedance mismatch tolerance. The flow continues to block 412 in FIG. 4B.

At block 412, the PLC device can determine whether a termination of the broadcast PLC message is detected. For example, the broadcast PLC message can terminate when the transmitting PLC device 302 has completed sending the PLC data associated with the broadcast PLC message. If the PLC device determines that the termination of the broadcast PLC message is not detected, (i.e., the broadcast PLC message is still being received), then the flow continues to block 414. At block 414, the modified input impedance of the PLC device is maintained. Thus, if the input impedance of the PLC device was previously modified, then the input impedance of the PLC device is maintained at those modified values. The flow returns to block 412.

Returning to block 412, if the PLC determines that the termination of the broadcast PLC message is detected or inferred (i.e., the broadcast PLC message is no longer being received), then the flow continues to block 416. At block 416, the input impedance of the PLC device can be returned to an initial value. Returning the input impedance of the PLC device to the initial value can prepare the PLC device to receive another PLC message by setting the input impedance to a predetermined value. The flow returns to block 402 in FIG. 4A.

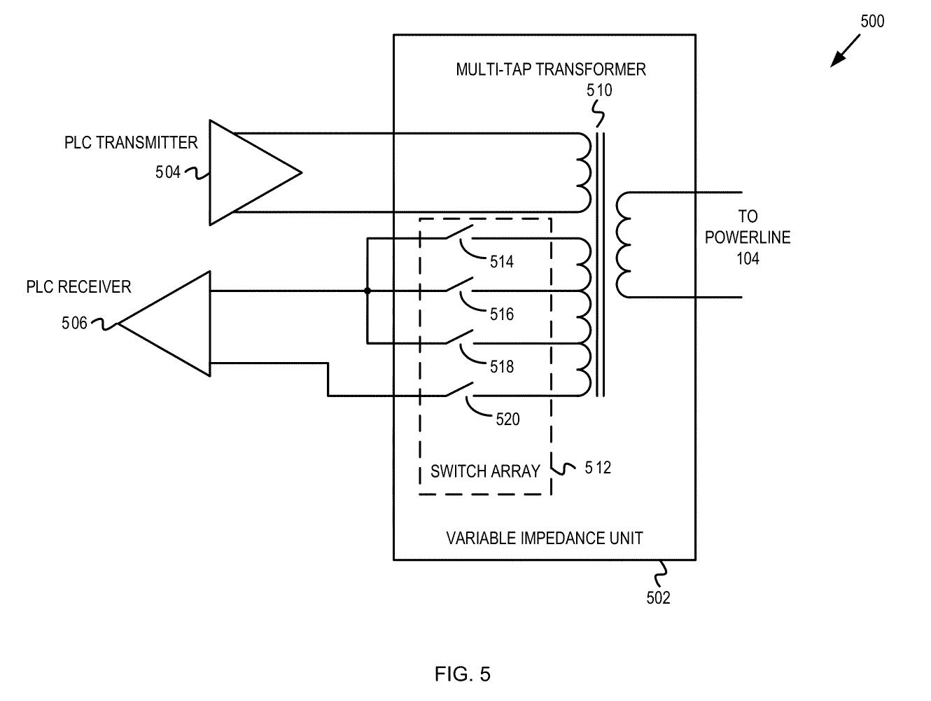

FIG. 5 is a simplified diagram illustrating one embodiment of a PLC device 500 including a variable impedance unit 502. The PLC device 500 can include a PLC transmitter 504 and a PLC receiver 506. The variable impedance unit 502 can include a multi-tap transformer 510 and a switch array 512.

The powerline medium 104 can be coupled to a first side of the multi-tap transformer 510. A second side of the multi-tap transformer 510 can be coupled to the PLC transmitter 504. The PLC receiver 506 can also be coupled to the second side of the multi-tap transformer 510 through the switch array 512. The switch array 512 can couple different taps of the multi-tap transformer 510 to the PLC receiver 506. The different taps can select different input impedances for the PLC receiver 506. The different input impedances can be based, at least in part, on different resistances of the different taps of the multi-tap transformer 510. The PLC signals are wideband signals and can have a frequency range from 2 MHz to 68 MHz. A resistive approach to the variable impedance unit 502 as shown here can have a flat and wideband response over the PLC frequency range. In one embodiment, the switch array 512 can decouple the PLC receiver 506 from the multi-tap transformer 510 when the PLC transmitter 504 is active. Decoupling the multi-tap transformer 510 can simplify some PLC receiver 506 designs by isolating high power PLC signals from the PLC transmitter 504 away from the PLC receiver 506. The example of FIG. 5 depicts the switch array 512 including four switches. In FIG. 5, switches 514, 516, and 518 are connected to the upper rail of the PLC receiver 506; while switch 520 is connected to the lower rail of the PLC receiver 506. The example configuration of the switch array 512 allows for four possible transformer winding combinations facing the PLC receiver 506, namely, A) all switches open, B) switches 514 and 520 closed, C) switches 516 and 520 closed, and D) switches 518 and 520 closed. However, other configurations and interconnections using any suitable number of switched in the switch array 512 are possible.

It should be understood that FIGS. 1-5 and the operations described herein are examples meant to aid in understanding embodiments and should not be used to limit embodiments or limit scope of the claims. Embodiments may perform additional operations, fewer operations, operations in a different order, operations in parallel, and some operations differently. The disclosed embodiments are not meant to limit the disclosure. Other embodiments are contemplated.

For example, in one embodiment, the PLC devices can each monitor the PLC signal strength of the received unicast or broadcast PLC messages. The PLC devices can modify the corresponding input impedance based on the PLC signal strength, SNR, noise floor of the unicast or broadcast PLC message or other signal margins related to the received PLC signals. In another embodiment, the PLC devices can modify the related input impedance based on a signal-to-noise ratio or signal-to-noise plus interference determined at an output of analog-to-digital converter included in the PLC receiver 506.

As described above, a transmitting PLC device may select multiple PLC devices to receive a broadcast or unicast message. The input impedance of the terminal PLC device may be matched to within the primary matching tolerance of the powerline medium impedance. In some embodiments, the input impedance of each of the other selected PLC devices (i.e., non-terminal PLC devices) may be matched to within a common secondary matching tolerance of the powerline medium impedance. In another embodiment, one or more of the other selected PLC devices may be associated with a different secondary matching tolerance. For example, a first subset of the other selected PLC devices may be matched to within a secondary matching tolerance, and a second subset of the other selected PLC devices may be matched to a different secondary matching tolerance as the first subset of the other selected PLC devices. In some embodiments, the secondary matching tolerance associated with each of the other selected PLC devices may be independently determined based, at least in part, on the number of selected PLC devices. In other embodiments, the secondary matching tolerance associated with the selected PLC device may be determined based on knowledge of the secondary matching tolerance associated with an upstream selected PLC device and the number of selected PLC devices in the downstream path.

As will be appreciated by one skilled in the art, aspects of the disclosure may be embodied as a system, method, or computer program product. Accordingly, aspects of the disclosure may take the form of an entirely hardware embodiment, a software embodiment (including firmware, resident software, micro-code, etc.) or an embodiment combining software and hardware aspects that may all generally be referred to herein as a “circuit,” “module”, “unit,” “device,” or “system.” Furthermore, aspects of the disclosure may take the form of a computer program product embodied in one or more computer readable medium(s) having computer readable program code embodied thereon.

Any combination of one or more computer readable medium(s) may be used. The computer readable medium may be a computer readable storage medium. A computer readable storage medium may be, for example, an electronic, magnetic, optical, electromagnetic, infrared, or semiconductor system, apparatus, or device, or any suitable combination of the foregoing. More specific examples of the computer readable storage medium may include a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The computer readable medium can include instructions for carrying out operations for aspects of the disclosure and may be written in any combination of one or more programming languages. Examples of programming languages can include an object oriented programming language such as Java, Smalltalk, C++, or the like and conventional procedural programming languages, such as the “C” programming language. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the disclosure are described with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to be executed.

The computer program instructions can be executed to direct a computer, other programmable data processing apparatus, or other devices to function in a particular manner in order to produce an article of manufacture including instructions which implement the function/act specified in the flowchart and/or block diagram block or blocks.

The computer program instructions may also be loaded onto a computer, other programmable data processing apparatus, or other devices. The computer program instructions can be executed to cause a series of operational steps to be performed to produce a computer implemented process such that the executed instructions can provide processes for implementing the functions/acts specified in the flowchart and/or block diagram block or blocks.

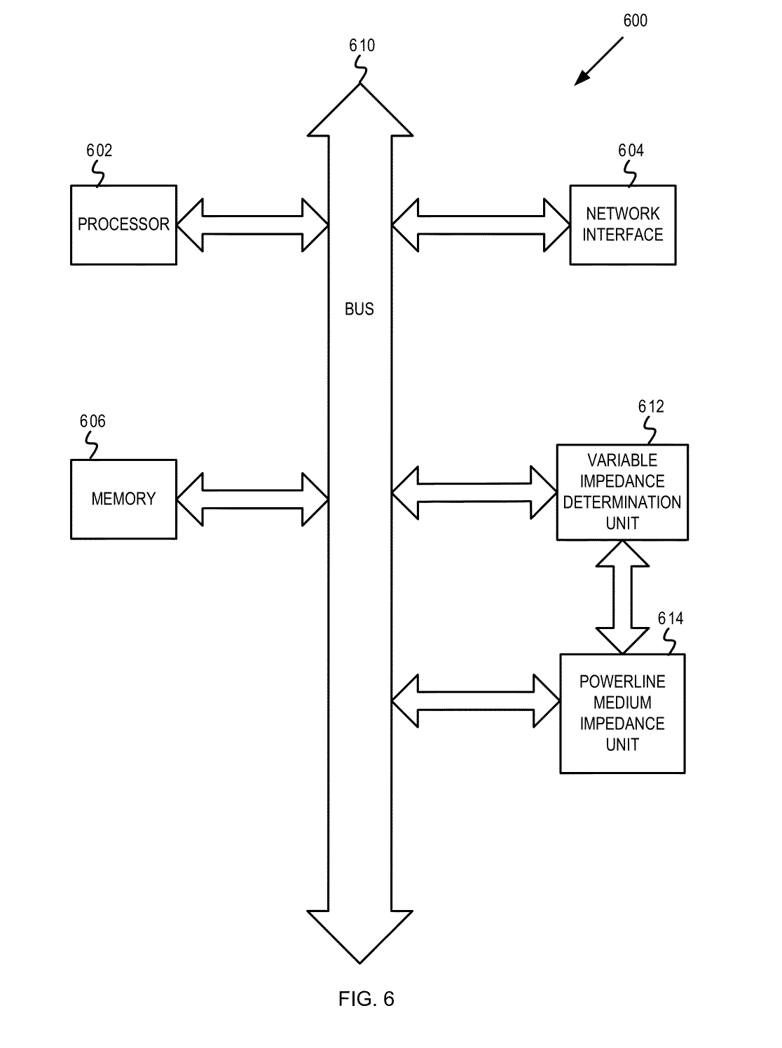

FIG. 6 is a block diagram of an exemplary embodiment of an electronic device 600 including a variable impedance determination unit 612 and a powerline medium impedance unit 614. In some implementations, the electronic device 600 may be one of a laptop computer, a tablet computer, a mobile phone, a PLC device, a smart appliance (PDA), a hybrid communication device, an access point, a wireless station or other electronic system. The electronic device 600 can include a processor 602 (possibly including multiple processors, multiple cores, multiple nodes, and/or implementing multi-threading, etc.). The electronic device 600 can also include a memory 606. The memory 606 may be a system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. Electronic device 600 can also include a bus 610 (e.g., PCI, ISA, PCI-Express, HyperTransport®, InfiniBand®, NuBus, AHB, AXI, etc.), and a network interface 604 that includes at least one of a wireless network interface (e.g., a WLAN interface, a Bluetooth® interface, a WiMAX interface, a ZigBee® interface, a Wireless USB interface, etc.) and a wired network interface (e.g., an Ethernet interface, a powerline communication interface, etc.). In some implementations, the electronic device 600 may support multiple network interfaces—each of which is configured to couple the electronic device 600 to a different communication network.

In one embodiment, the variable impedance determination unit 612 can determine whether to modify the input impedance of the wired network interface of the electronic device 600 as described in conjunction with FIGS. 1-5. For example, the variable impedance determination unit 612 can determine whether to modify the input impedance based, as least in part, on whether the electronic device 600 is receiving a unicast PLC message or a broadcast PLC message through the wired network interface. In one embodiment, the processor 602 can execute instructions stored in the memory 606 to implement embodiments described in FIGS. 1-5 above. Although shown separately, in some embodiments, the variable impedance determination unit 612 can be implemented using the processor 602 and the memory 606. For example, the processor 602 can execute instructions stored in the memory 606 to provide functionality for the variable impedance determination unit 612. The variable impedance determination unit 612 can be coupled to the powerline medium impedance unit 614. In one embodiment, the powerline medium impedance unit 614 can include the variable impedance units 120-124, the variable impedance units 320-324 or the variable impedance unit 502. In one embodiment, the powerline medium impedance unit 614 can modify the input impedance of the powerline communication interface of the electronic device 600 by selecting an input impedance for the PLC receiver 506. Although shown separately, in some embodiments, the powerline medium impedance unit 614 can be implemented partially or entirely using the network interface 604 and the bus 610.

Any one of these functionalities may be partially (or entirely) implemented in hardware and/or on the processor 602. For example, the functionality may be implemented with an application specific integrated circuit, in logic implemented in the processor 602, in a co-processor on a peripheral device or card, etc. Further, realizations may include fewer or additional components not illustrated in FIG. 6 (e.g., video cards, audio cards, additional network interfaces, peripheral devices, etc.). The processor 602, the memory 606, the network interface 604, the variable impedance determination unit 612, and the powerline medium impedance unit 614 are coupled to the bus 610. Although illustrated as being coupled to the bus 610, the memory 606 may be coupled to the processor 602.

While the embodiments are described with reference to various implementations and exploitations, it will be understood that these embodiments are illustrative and that the scope of the disclosure is not limited to them. In general, techniques for varying the input impedance as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the disclosure. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the disclosure.

What is claimed is:

1. A method comprising:
determining a destination address associated with a first powerline communication (PLC) signal received at a PLC device via a powerline medium;
determining whether an address of the PLC device matches the destination address; and
modifying an input impedance of the PLC device based, at least in part, on an impedance of the powerline medium and whether the address of the PLC device matches the destination address.

2. The method of claim 1, wherein, in response to determining the address of the PLC device does not match the destination address, modifying the input impedance of the PLC device comprises generating a mismatch between the input impedance of the PLC device and the impedance of the powerline medium.

3. The method of claim 2, wherein generating the mismatch is based, at least in part, on an impedance mismatch tolerance.

4. The method of claim 1, further comprising:
determining a termination of a PLC message, wherein the first PLC signal includes the PLC message; and
modifying the input impedance of the PLC device to an initial value with reference to the impedance of the powerline medium based, at least in part, on determining the termination of the PLC message.

5. The method of claim 1, wherein, in response to determining the address of the PLC device matches the destination address, modifying the input impedance of the PLC device comprises matching the input impedance of the PLC device with the impedance of the powerline medium.

6. The method of claim 5, wherein matching the input impedance of the PLC device is based, at least in part, on a primary matching tolerance associated with the impedance of the powerline medium.

7. The method of claim 1, further comprising:
determining whether the PLC device is associated with a high-traffic pathway; and
modifying the input impedance of the PLC device based, at least in part, on the impedance of the powerline medium and determining that the PLC device is associated with a high-traffic pathway.

8. The method of claim 1, further comprising:
determining whether the first PLC signal is received according to a time-division multiple access protocol; and
in response to determining that the first PLC signal is received according to the time-division multiple access protocol, modifying the input impedance of the PLC device based, at least in part, on a communication schedule for the time-division multiple access protocol.

9. The method of claim 1, wherein modifying the input impedance of the PLC device further comprises:
determining a first signal-to-noise measurement associated with the first PLC signal prior to modifying the input impedance of the PLC device;
determining a second signal-to-noise measurement associated with a second PLC signal received after modifying the input impedance of the PLC device; and
determining whether to modify the input impedance of the PLC device to an initial value based, at least in part, on whether the first signal-to-noise measurement is greater than the second signal-to-noise measurement.

10. The method of claim 1, wherein modifying the input impedance of the PLC device is based, at least in part, on detecting a request-to-send PLC message and a clear-to-send PLC message.

11. A method comprising:
determining a destination address associated with a first powerline communication (PLC) signal received at a first PLC device from a second PLC device via a powerline medium;
determining whether an address of the first PLC device matches the destination address;
determining a first distance between the first PLC device and the second PLC device;
determining a second distance between the second PLC device and a third PLC device; and
modifying an input impedance of the first PLC device based, at least in part, on an impedance of the powerline medium, the first distance, the second distance, and whether the address of the first PLC device matches the destination address.

12. The method of claim 11, wherein modifying the input impedance of the first PLC device comprises:
determining whether to match the input impedance of the first PLC device to the impedance of the powerline medium based, at least in part, on whether the first distance is greater than the second distance and whether the address of the first PLC device matches the destination address.

13. The method of claim 11, wherein modifying the input impedance of the first PLC device comprises:
determining whether the second distance is greater than the first distance; and
matching the input impedance of the first PLC device to an alternate impedance within a secondary matching tolerance of the impedance of the powerline medium based, at least in part, on determining that the second distance is greater than the first distance.

14. The method of claim 11, wherein modifying the input impedance of the first PLC device further comprises:
generating a mismatch between the impedance of the first PLC device and the impedance of the powerline medium.

15. The method of claim 11, wherein modifying the input impedance of the first PLC device further comprises:
determining a first noise floor measurement associated with the first PLC signal prior to modifying the input impedance of the first PLC device;
determining a second noise floor measurement associated with a second PLC signal received after modifying the input impedance of the second PLC device; and
modifying the input impedance of the first PLC device to an initial value based, at least in part, on the first noise floor measurement and the second noise floor measurement.

16. The method of claim 11, further comprising:
determining a termination of a PLC message at the first PLC device, wherein the first PLC signal includes the PLC message; and
modifying the input impedance of the first PLC device to an initial value based, at least in part, on determining the termination of the PLC message.

17. A non-transitory machine-readable storage medium having machine executable instructions stored therein, the machine executable instructions comprising instructions to:
determine a destination address associated with a first powerline communication (PLC) signal received at a PLC device via a powerline medium;
determine whether an address of the PLC device matches the destination address; and
modify an input impedance of the PLC device based, at least in part, on an impedance of the powerline medium and whether the address of the PLC device matches the destination address.

18. The non-transitory machine-readable storage medium of claim 17, wherein:
the instructions to modify the input impedance of the PLC device comprise instructions to generate a mismatch between the input impedance of the PLC device and the impedance of the powerline medium in response to determining the address of the PLC device does not match the destination address.

19. The non-transitory machine-readable storage medium of claim 18, wherein the instructions to generate the mismatch is based, at least in part, on an impedance mismatch tolerance.

20. The non-transitory machine-readable storage medium of claim 17, further comprising instructions to:
determine a termination of a PLC message at the PLC device, wherein the PLC signal includes the PLC message; and
modify the input impedance of the PLC device to an initial value with reference to the impedance of the powerline medium based, at least in part, on determining the termination of the PLC message.
